(19) United States
(12) Patent Application Publication
(10) Pub. No.: US 2022/0113832 A1
(43) Pub. Date: Apr. 14, 2022

(54) Touchless Display Interface System

(71) Applicant: Zhenwu Huang, Las Vegas, NV (US)

(72) Inventor: Zhenwu Huang, Las Vegas, NV (US)

(21) Appl. No.: 17/315,978

(22) Filed: May 10, 2021

Related U.S. Application Data
(60) Provisional application No. 63/091,137, filed on Oct. 13, 2020.

(51) Int. Cl. G06F 3/042; G06F 3/041

(52) U.S. Cl. CPC G06F 3/0421; G06F 2203/04109; G06F 2203/04108; G06F 3/0412

(57) ABSTRACT

A touchless display interface system having a fixed outer shell having a length, width and depth which houses one or more circuit boards including one or more infrared touch modules and one or more touch drive modules. The invention further includes one or more communication modules, one or more indicator light trigger drive modules, one or more infrared filter strips, and a light guide. The fixed outer shell houses the components and is configured to attach to a computer display and provide a touchless operating environment inside area created by the length, width and depth of the generally rectangular shaped fixed outer shell. A method of operation is also disclosed.

### CROSS-REFERENCE TO RELATED APPLICATIONS

The present utility patent application claims priority benefit of the U.S. provisional application for patent Ser. No. 63/091,137 titled “Touchless Display Interface System,” filed on Oct. 13, 2020 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of interactive computer displays. More specifically, the present invention relates to a touchless display interface system which can be installed on a display terminal device that provides query information services and complete selection and control operations required by individuals without touching the display.

### 2. Description of the Related Art

Computer displays or monitors are output devices that computers use to convey information. Display technology has evolved over the years with today's LCD and LED monitors taking up less space and providing seemingly unlimited graphics capabilities. Along with better graphics, today's computer displays often come with touch screen technology which enables a user to perform functions on the display itself without the need of interface devices such as keyboards and mice.

The world has also become increasingly aware of the dangers of highly contagious diseases how infectious diseases spread. Contaminated objects and surfaces, sometimes referred to as fomites, are particularly hazardous when it comes to the spread of infectious disease. Surfaces may become contaminated by pathogens through coughing, sneezing and/or shedding by touch. Due to the COVID-19 pandemic, improved systems and methods for the prevention of transmission of harmful pathogens are not only desired, improved systems and methods for the prevention of transmission of harmful pathogens have become a necessary element in living, work and public spaces.

Presently, there exists a need for a touchless display interface system and method which can be installed on a display terminal device that can provide query information services and complete selection and control operations required by individuals without touching the display. Such a system must be able to effectively provide a user interface for computer systems ranging from tablet computers, home computers, and public use computers such as, but not limited to, computer kiosks, automated teller machines (ATMs), cash registers, and information systems. Additionally, such a touchless display interface system is optimized to meet or exceed current health and safety standards.

### SUMMARY

The present invention is directed a touchless display interface system and method which can be installed on a display terminal device that provides query information services and complete selection and control operations required by individuals without touching the display. The primary function of the invention is to carry out touchscreen-equivalent functionality in a touchless, non-contact method. The invention employs infrared radiation sensor technology to exchange the coordinate information generated when an opaque object passes through the infrared mapping module with the computer to complete the touchscreen-equivalent operation.

A specific function of the invention relates to display terminal equipment used to provide operation in all public places such as shopping malls, office buildings, libraries, stations, airports, etc. By installing a touchless display interface system, whether as a retrofit to existing systems or as a new system, a non-contact display terminal can be created to select and operate a computer, thus minimizing contact and the spread of bacteria and viruses. Such an invention can provide a better healthier and safer user environment and can also effectively protect the privacy of the operator.

The invention includes a fixed outer shell having a length, width and depth which houses one or more circuit boards including one or more infrared touch modules and one or more touch drive modules. The invention also includes one or more communication modules, one or more indicator light trigger drive modules, one or more infrared filter strips, and a light guide. The fixed outer shell having a length width and depth houses the components and is configured to attach to a computer display and provide a touchless operating environment inside area created by the length, width and depth of the generally rectangular shaped fixed outer shell.

When a user's finger selects the content of the display screen, when the finger points to the display screen and passes through the infrared touch module, the infrared touch module detects through infrared radiation and exchanges data with the computer through the touch drive module, and the LED lights Trigger the drive module through the level signal generated by the touch drive module, drive the LED light module to turn on to remind people to select operations, avoid hand contact with display equipment, reduce the spread of bacteria and viruses through contact, and protect our healthy lifestyle

The invention can be implemented as a retrofit kit. Alternatively, the invention can also be sold together with tablet computers, cash registers, advertising machines, and all electronic devices with flat screens.

### BRIEF DESCRIPTION OF THE DRAWINGS

The invention directed by way of example, and not by way of limitation, in the figures of the accompanying drawings and in which like reference numerals refer to similar elements and in which:

FIG. 1 is a perspective view of an exemplary touchless display interface system in accordance with an embodiment of the invention;

FIG. 2 is an exploded perspective view of a touchless display interface system in accordance with an embodiment of the invention;

FIG. 3 is a perspective view of a generally rectangular circuit board in accordance with an embodiment of the invention;

FIG. 4 is a front elevation view of an exemplary touchless display interface system in accordance with an embodiment of the invention;

FIG. 5 is a rear elevation view of an exemplary touchless display interface system in accordance with an embodiment of the invention;

FIG. 6 is a side plan view of an exemplary touchless display interface system in accordance with an embodiment of the invention;

FIG. 7 is a top plan view of an exemplary touchless display interface system in accordance with an embodiment of the invention; and

FIG. 8 is a perspective view representing a user performing tasks with a touchless display interface system in accordance with an embodiment of the invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant,” do not necessarily refer to the same embodiment although they may. A description of an embodiment with several components in communication with each other does not imply that all such components are required. On the contrary, a variety of optional components are described to illustrate the wide variety of possible embodiments and/or variants of the present invention.

A “computer” may refer to one or more apparatus and/or one or more systems that are capable of accepting a structured input, processing the structured input according to prescribed rules, and producing results of the processing as output. Examples of a computer may include: a personal computer (PC); a stationary and/or portable computer; a computer having a single processor, a computer having multiple processors, or a computer having multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer; a personal digital assistant (PDA); a portable telephone; a portable smartphone; wearable devices such as smartwatches; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

The term “processor” may refer to any device or portion of a device that processes electronic data from registers and/or memory to transform that electronic data into other electronic data that may be stored in registers and/or memory. A “computing platform” may comprise one or more processors.

A “computer monitor” or “display” is an output device that displays information in pictorial form. A monitor usually comprises the visual display, circuitry, casing, and power supply. The display device in modern monitors is typically a thin film transistor liquid crystal display (TFT-LCD) with LED backlighting having replaced cold-cathode fluorescent lamp (CCFL) backlighting. Monitors are typically connected to computers via VGA, Digital Visual Interface (DVI), S-Video, HDMI, DisplayPort, Thunderbolt, low-voltage differential signaling (LVDS) or other proprietary and/or integrated connectors and signals.

It will be readily understood by persons skilled in the art that the various methods and algorithms described herein may be implemented by appropriately programmed computers and computing devices. Typically, a processor (e.g., a microprocessor) will receive instructions from a memory or memory-like device, and execute those instructions, thereby performing a process defined by those instructions. Further, programs that implement such methods and algorithms may be stored and transmitted using a variety of known media.

“Software” may refer to prescribed rules and/or instructions used to operate a computer. Examples of software may include code segments in one or more computer-readable languages; graphical and or/textual instructions; applets; pre-compiled code; interpreted code; compiled code; and computer programs. An operating system or “OS” is software that manages computer hardware and software resources and provides common services for computer programs.

Certain embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including object oriented programming languages and/or conventional procedural programming languages, and/or programming languages or other compilers, assemblers, interpreters or other computer languages or platforms.

A “computer system” may refer to a system having one or more computers, where each computer may include a computer-readable medium employing software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

As is well known to those skilled in the art, many careful considerations and compromises typically must be made when designing the optimal manufacture or commercial implementation of such a touchless display interface system. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

The exemplary touchless display interface system will now be described in detail with reference to embodiments thereof as illustrated in the accompanying drawings. Unless otherwise indicated illustrations in the figures are not necessarily drawn to scale.

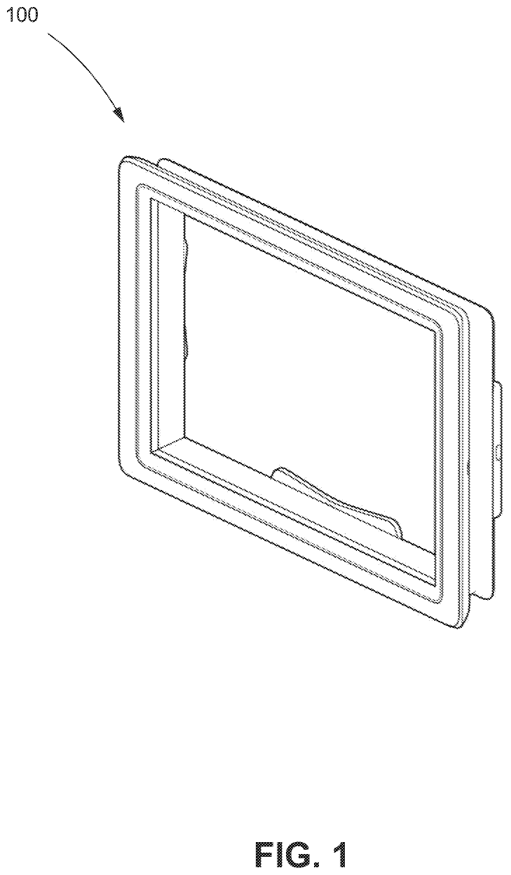

FIG. 1 is a perspective view of an exemplary touchless display interface system in accordance with an embodiment of the invention. In various embodiments of the invention, the touchless display interface system 100 can attach to existing computer monitors to provide a touchless interface. Embodiments of the invention can attach to monitor stands and integrate into existing systems. Persons having skill in the art will appreciate that different appearances for such a view can be achieved through the use of different parts and components which perform the same or similar functions as the components which are to be disclosed in the present invention.

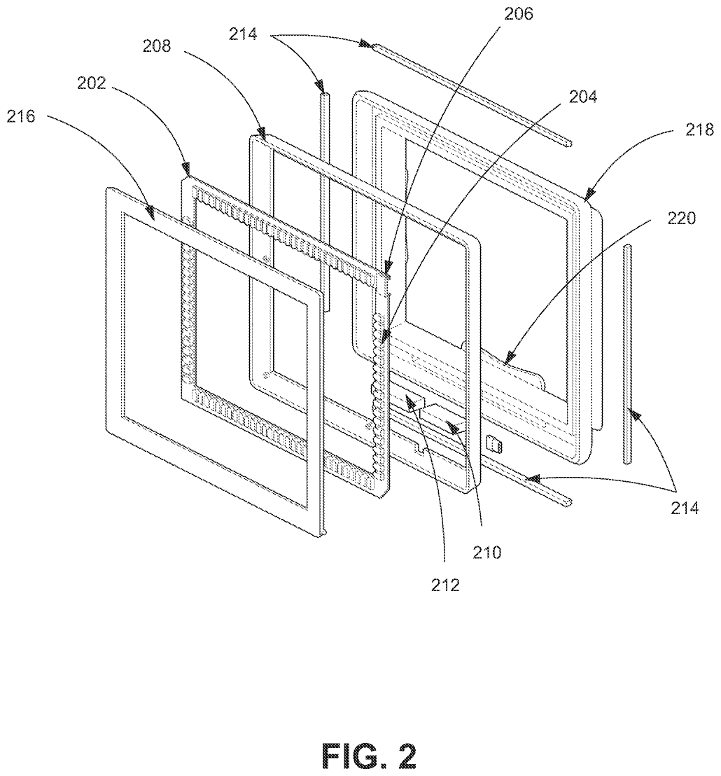

FIG. 2 is an exploded perspective view of a touchless display interface system in accordance with an embodiment of the invention. The invention also includes a generally rectangular shaped fixed outer shell 218 having a length, width and depth. In an embodiment of the invention, generally rectangular shaped fixed outer shell 218 having a length, width and depth houses one or more generally rectangular shaped circuit boards 202 including at least one infrared touch module 204 and a touch drive module 206. The fixed outer shell 218 further houses one or more communication modules 210, an indicator light trigger drive module 212, one or more infrared filter strips 214 and a light guide 208. In an embodiment of the invention, the fixed outer shell having a length width and depth 218 is configured to attach to a computer display and provide a touchless operating environment inside the cavity or hollow body created by the length, width and depth of the said generally rectangular shaped fixed outer shell. Persons having skill in the art will readily appreciate that the cavity or hollow body created by the length, width and depth of the said generally rectangular shaped fixed outer shell can vary in length, width and depth depending on several factors including, but not limited to, the size of the computer display to be used, the need for user privacy and the need for protecting the computer display itself.

In one embodiment of the invention, the touchless display interface system uses one or more layers of infrared touch modules 204. Each infrared touch module 204 adopts infrared emitting diodes and infrared receiving diodes to form a crisscrossed infrared display network in the same or multiple planes. The infrared display network can be achieved with one or more rectangular circuit boards having one or more layers of infrared touch modules 204. An infrared touch drive module 206 functions to exchange positional value information generated by the one or more infrared touch modules 204 with a computer, and to exchange other relevant data with a connected computer. In an embodiment of the invention, the touch drive module 206 contains a driver diode chip such as, but not limited to, a S8550 transistor. The touch drive module can also include metal-oxide semiconductor drive chip such as, but not limited to, 2SD1664 transistor and/or a 74HC595 shift register. The generated high level and low-level signals are sent to the LED light trigger drive module 212, and its connection with the computer includes, but is not limited to, USB, serial port, wireless and Bluetooth. In an embodiment of the invention, the trigger drive modules 212 includes a microcontroller chip such as, but not limited to, STM8S005K6T6C, a level conversion chip such as, but not limited to, SPIEX3232, an analog channel chip such as, but not limited to 74HC4051, and an operational amplifier chip such as, but not limited to, LMV358. In one embodiment of the invention, 78 equally spaced infrared emitting diode (IRED) and infrared receiver triode modules are used. Persons having skill in the art will appreciate that a combination of different diode and/or triode modules can be used to create a layer of infrared touch modules 204.

The touch point of the object on the plane is determined by the blocking or interfering with the horizontal and vertical infrared rays by a non-transparent object. Persons having skill in the art will appreciate that the function of the touch drive module 206 is to determine the X, Y coordinate value of the object in the plane and to send a signal to one or more communication modules 210 which can communicate unidirectionally or bidirectionally with a connected or networked computer with the touchless display interface system.

The communication module 210 is mounted on a printed circuit board which supports the functions of either a wired USB connection and a near-field communication (NFC) or Bluetooth connection. In one embodiment of the invention, the communication module can include a Bluetooth frequency chip such as, but not limited to, model BC417143B. Persons skilled in the art will understand that other suitable and/or analagous replacement chip sets can be used. The communication module 210 further includes a microcontroller chip such as, but not limited to, a 512K×16 CMOS Multi-Purpose Flash (MPF) model SST39WF800A. The communication module further includes a power supply chip such as, but not limited to, model RT9030 A-33GB and a level conversion chip such as, but not limited to, model SIPX3232.

When the infrared touch module 204 detects an object, it exchanges data with a connected or networked computerthrough a communication protocol between the touch drive module 206 and the one or more communication modules 210. Simultaneously, the indicator light trigger drive module 212 commands an light module to turn on and light up one or more LED indicator light modules 302.

The one or more infrared filter strips 214 act to filter light waves outside the infrared band emitted by the infrared emitting tubes or diodes or sensors of the infrared touch module 204. Each infrared filter strip 214 serves to reduce the interference of other electromagnetic spectrum bands to the infrared touch module 204 and touch drive module 206. Persons having skill in the art will readily appreciate that various infrared sensing technologies are available to successfully implement such infrared filter strips 214. In one embodiment of the invention, the filter strips are made from a material such as, but not limited to, polyvinyl chloride which allows infrared radiation to pass through while blocking other wavelengths of light.

The fixed clip 220 is used to install and fix the touchless display interface system to a display terminal. The touchless display interface system can use an iron or ferromagnetic sheet on the fixed clip and employ magnets on the fixed shell 218 to fix the touchless display interface system on the front end of the display device. Persons having skill in the art will readily appreciate that the fixed clip 218 can assume numerous shapes and dimensions in order to serve its function.

It will be readily apparent to persons having skill in the art that the touchless display interface system may be powered by numerous means known and appreciated in the art. In one embodiment, the touchless display interface system has a USB connector and connects to a computer system. In other embodiments, the touchless display interface system may be powered independently through stand AC power means. In other embodiments, the touchless display interface system can be powered by DC battery means.

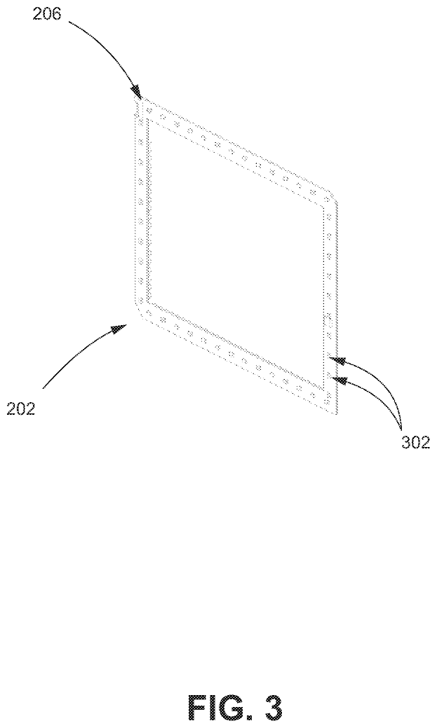

FIG. 3 is a perspective view of a generally rectangular circuit board in accordance with an embodiment of the invention. In this view, and in contrast to the view shown in FIG. 2, the reverse side of the generally rectangular circuit board is shown. On one side of the generally rectangular circuit board, at least one infrared touch module and a touch drive module 206 are included. On the opposite side, one or more LED light modules 302 are included. Persons having skill in the art will understand that the LED light modules can be on the same rectangular shaped circuit board as the infrared touch modules 204 or it can be on a separate rectangular shaped circuit board depending on factors such as, but not limited to, the size of the touchless display system or the size of the computer display.

The LED light module 302 is used for when a user's finger passes through the electromagnetic field created by one or more infrared touch modules 204. In an embodiment of the invention, the infrared touch module 204 detects motion inside an electromagnetic field which, in turn, can activate the LED light modules. In embodiments of the invention, the LED light module 302 can use various RGB LED lights which change color through programming. Depending on position, the LED light module can change color to assist a user in determining whether an object has been selected in an interface. The LED light module 302 is turned on to remind the user when a hand has entered the operating area. In one embodiment of the invention, the touchless display interface system uses one layer of infrared touch modules 204. In an alternate embodiment of the invention, the touchless display interface system uses two or more layers of infrared touch modules 204. When a user's finger or appendage enters a specific depth in the housing layer of infrared touch module 204, the LED light module 302 changes to another color, and the prompt function is equivalent to a mouse clicking. Persons having skill in the art will readily appreciate that numerous types of LED lights can be used to create various light effects when activated by the indicator light trigger drive module 212.

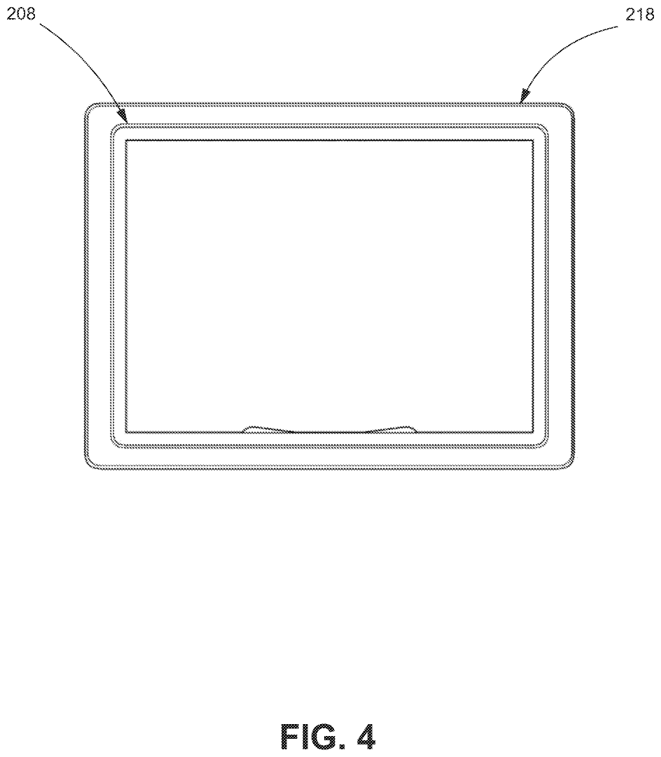

FIG. 4 is a front elevation view of an exemplary touchless display interface system in accordance with an embodiment of the invention. a generally rectangular shaped fixed outer shell 218 having a length, width and depth which houses the circuit board(s) including an infrared touch module 204 and a touch drive module 206, the communication module 210, the indicator light trigger drive module 212, the infrared filter strip 214 and the light guide 208; said fixed outer shell having a length width and depth configured to attach to a computer display and provide a touchless operating environment inside the length, width and depth of the said generally rectangular shaped fixed outer shell. The light guide 208 can be made from any suitable material capable of reflecting and/or refracting light from the LED light module 302 for a user to see.

A fixed shell front panel 216 provides added rigidity and protection for the touchless display interface system. Such a fixed shell front panel can attach to the fixed outer shell 218 by numerous means such as, but not limited to, a tongue-in-groove mechanism or can simply be attached by a chemical adhesive. Persons skilled in the art will understand that other methods and equipment can be used to attach a fixed shell front panel to a fixed outer shell.

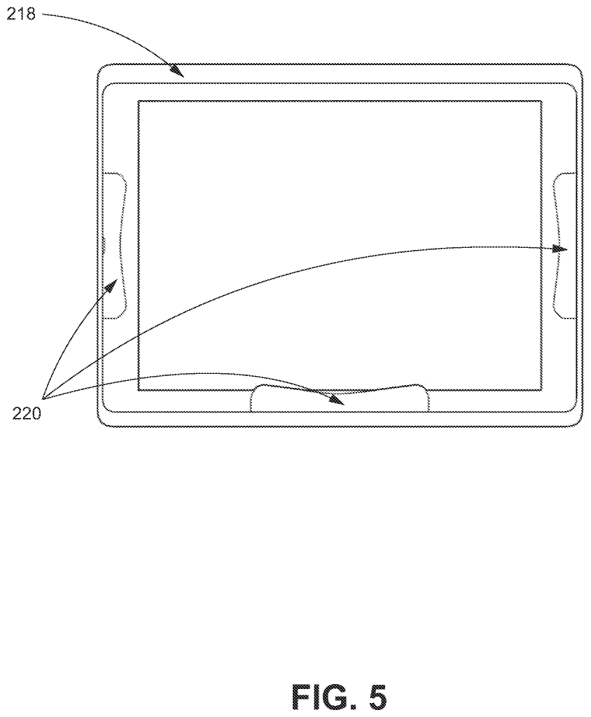

FIG. 5 is a rear elevation view of an exemplary touchless display interface system in accordance with an embodiment of the invention. In an embodiment of the invention, one or more fixed clips 220 are attached to the fixed shell 218 and serve to hold the touchless display interface system in place. In one embodiment of the invention, the touchless display interface system is configured in such a way that a tablet or computer display can be slidingly inserted into the one or more fixed clips and held in place by the clips. Persons skilled in the art will readily appreciate how a fixed clip system can hold a computer display in place and will understand that other methods and equipment can also be used to attach a touchless display interface system to an existing display.

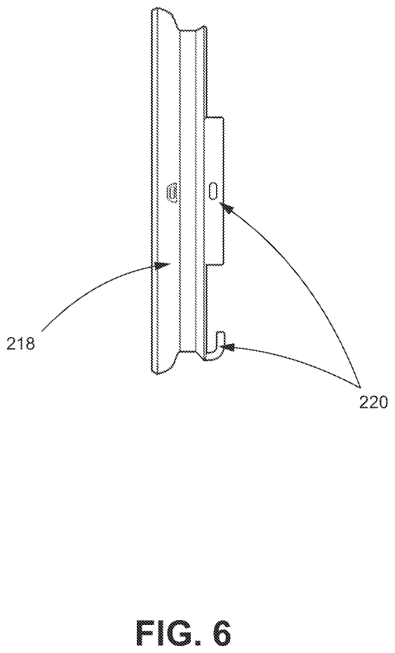

FIG. 6 is a side plan view of an exemplary touchless display interface system in accordance with an embodiment of the invention. In an embodiment of the invention, the fixed clip 220 attaches to the fixed shell 218 and serves to hold the touchless display interface system in place. By way of example, and not limitation, the touchless display interface system can simply slide onto a computer display. The fixed clip 220 is used to install and fix the touchless display interface system to a display terminal. Persons skilled in the art will understand that other methods and equipment can be used to attach a touchless display interface system to an existing display. Moreover, persons having skill in the art will understand that numerous means such as, but not limited to, magnets, spring clips, screws, fasteners, welds, adhesives or gaskets can keep the touchless display interface system attached to a computer display system.

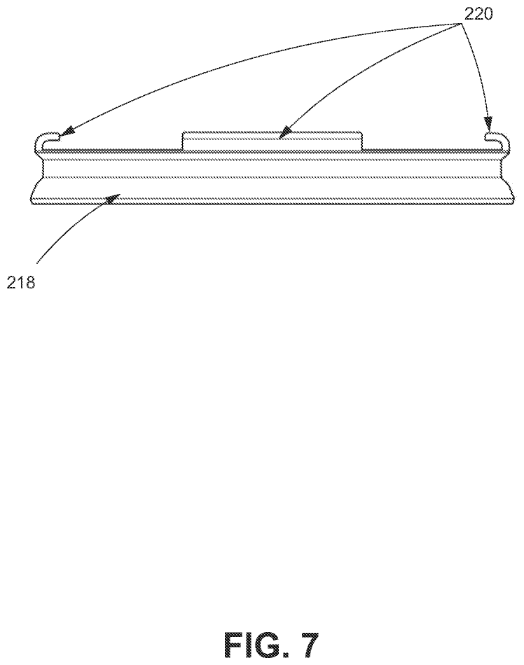

FIG. 7 is a top plan view of an exemplary touchless display interface system in accordance with an embodiment of the invention. The touchless display interface system is held in place by one or more fixed clips 220. A fixed outer shell 218 provides added rigidity and protection for the touchless display interface system. Persons skilled in the art will understand that other methods and equipment can be used to attach a touchless display interface system to an existing display.

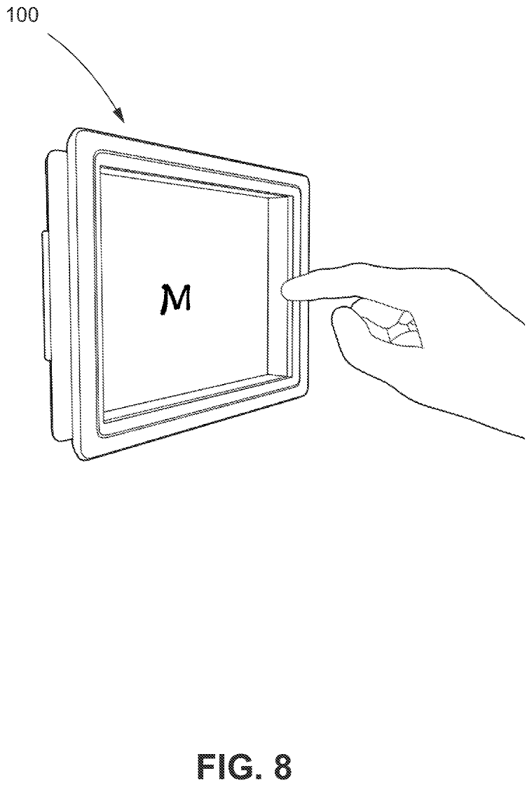

FIG. 8 is a perspective view representing a user performing tasks with a touchless display interface system 100 in accordance with an embodiment of the invention. When a user's finger crosses or enters the first layer, the function is limited to a cursor function to move a cursor over desired objects on the display. Stated differently, all a user has to do is move his or her finger in this plane to perform such a cursory function.

As a method of operation, the invention is directed to a non-transitory computer readable storage medium storing one or more programs configured for execution by one or more processors of a touchless display interface system having a generally rectangular shaped circuit board including one or more infrared touch modules and a touch drive module; one or more communication modules; one or more indicator light trigger drive modules; one or more infrared filter strips; and a light guide, said touchless display interface system networked with one or more computers having a display; the one or more programs comprising instructions for: displaying a cursor on a computer display; detecting a digit or appendage from a user; determining the dynamic X, Y and Z coordinates of the digit or appendage from a user; and exchanging data with a computer display.

Having fully described at least one embodiment of the touchless display interface system, other equivalent or alternative methods of implementing such an automated touchless display interface system according to the present invention will be apparent to those skilled in the art. Various aspects of the invention have been described above by way of illustration, and the specific embodiments disclosed are not intended to limit the invention to the particular forms disclosed. The particular implementation of the touchless display interface system may vary depending upon the particular context or application. By way of example, and not limitation, the touchless display interface system described in the foregoing was principally directed to providing a touchless display for computer monitors. However, similar techniques may instead be applied to other monitors where touchless systems are required, such as cash registers, kiosks, and automated teller machines, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Although specific features of the touchless display interface system are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively and are not limited to any physical interconnection. Claim elements and flowchart steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A touchless display interface system comprising:
a. a generally rectangular shaped circuit board including one or more infrared touch modules and a touch drive module;
b. a communication module;
c. an indicator light trigger drive module;
d. one or more LED indicator light modules
e. one or more infrared filter strips; and
f. a light guide.

2. The touchless display interface system of claim 1 further comprising a generally rectangular shaped fixed outer shell having a length, width and depth which houses the generally rectangular shaped circuit board including an infrared touch module and a touch drive module, the communication module, the indicator light trigger drive module, one or more LED indicator light modules, the one or more infrared filter strips and the light guide said fixed outer shell having a length width and depth configured to attach to a computer display with one or more fixed clips and provide a touchless operating environment inside the length, width and depth of the said generally rectangular shaped fixed outer shell.

3. The touchless display interface system of claim 1 wherein the generally rectangular shaped circuit board including one or more infrared touch modules and touch drive module includes a plurality of infrared transmitting and receiving tubes so as to form a crisscross infrared sensing and signaling network.

4. The touchless display interface system of claim 1 wherein the infrared touch module gathers interactive data from a user's finger or other appendage placed inside the general perimeter of the generally rectangular shaped circuit board including one or more infrared touch modules and a touch drive module.

5. The touchless display interface system of claim 1 wherein the generally rectangular shaped circuit board including one or more infrared touch modules and touch drive module activates an indicator light trigger drive module which activates the one or more LED indicator light modules when a user's finger or other appendage is inserted to a specific depth inside the perimeter of the generally rectangular shaped circuit board.

6. The touchless display interface system of claim 1 wherein the generally rectangular shaped circuit board including one or more infrared touch modules and touch drive module includes a touch drive module which exchanges data obtained by the said infrared touch module with the communication module.

7. The touchless display interface system of claim 1 wherein the communication module exchanges data obtained from the infrared touch module of generally rectangular shaped circuit board including one or more infrared touch modules and touch drive module includes a touch drive module with one or more computers having display networked with the said touchless display interface system.

8. The touchless display interface system of claim 1 wherein the one or more infrared filter strips can filter light waves outside of the infrared wavelength spectrum so as to reduce interference from light wavelengths outside the infrared wavelength spectrum.

9. The touchless display interface system of claim 1 wherein the indicator light module is connected with the indicator light trigger drive module.

10. A touchless display interface system, the system comprising:
a. a generally rectangular shaped frame having a length, width and depth, the said length, width and depth of the generally rectangular shaped frame used to create an operating environment in which a user can operate the touchless display interface system;
b. a housing located in the said generally rectangular frame having a length, width and depth in which a display device is mounted; and
c. a housing in the said generally rectangular frame having a length, width and depth which one or more infrared touch modules, a touch drive module, a communication module, an indicator light trigger drive module, one or more LED indicator light modules, one or more infrared filter strips and a light guide are mounted.

11. The touchless display interface system of claim 10 wherein the generally rectangular shaped circuit board including one or more infrared touch modules and touch drive module includes a plurality of infrared transmitting and receiving tubes so as to form a crisscross infrared sensing and signaling network.

12. The touchless display interface system of claim 10 wherein the generally rectangular shaped circuit board including one or more infrared touch modules and touch drive module includes a touch drive module which exchanges data obtained by the said infrared touch module with the communication module.

13. The touchless display interface system of claim 10 wherein the one or more infrared touch modules gather interactive data from a user's finger or other appendage placed inside the general perimeter of the generally rectangular shaped circuit board including an infrared touch module and a touch drive module.

14. The touchless display interface system of claim 10 wherein the generally rectangular shaped circuit board including one or more infrared touch modules and touch drive module activates an indicator light trigger drive module which activates the one or more LED indicator light modules when a user's finger or other appendage is inserted to a specific depth inside the perimeter of the generally rectangular shaped circuit board.

15. The touchless display interface system of claim 10 wherein the generally rectangular shaped circuit board including one or more infrared touch modules and touch drive module includes a touch drive module which exchanges data obtained by the said infrared touch module with the communication module.

16. The touchless display interface system of claim 10 wherein the communication module exchanges data obtained from the infrared touch module of generally rectangular shaped circuit board including one or more infrared touch modules and touch drive module includes a touch drive module with one or more computers having display networked with the said touchless display interface system.

17. The touchless display interface system of claim 10 wherein the infrared filter strip can filter light waves outside of the infrared wavelength spectrum so as to reduce interference from light wavelengths outside the infrared wavelength spectrum.

18. The touchless display interface system of claim 10 wherein the indicator light module is connected with the indicator light trigger drive module.

19. A non-transitory computer readable storage medium storing one or more programs configured for execution by one or more processors of a touchless display interface system having a generally rectangular shaped circuit board including one or more infrared touch modules and a touch drive module; a communication module; an indicator light trigger drive module; one or more infrared filter strips; and a light guide, said touchless display interface system networked with one or more computers having a display; the one or more programs comprising instructions for:
a. Displaying a cursor on a computer display;
b. Detecting a digit or appendage from a user;
c. Determining the dynamic X, Y and Z coordinates of the digit or appendage from a user; and
d. Exchanging data with a computer display.

20. The method of claim 19 wherein the one or more programs configured for execution by one or more processors controls an indicator light trigger drive module which activates the one or more LED indicator light modules when a user's finger or other appendage is inserted to a specific depth inside the perimeter of the generally rectangular shaped circuit board.
